(19) United States
(12) Patent Application Publication
(10) Pub. No.: US 2017/0131435 A1
(43) Pub. Date: May 11, 2017

(54) LOCALIZED WEATHER PREDICTION

(71) Applicant: HERIOT-WATT UNIVERSITY, Edinburgh (GB)

(72) Inventors: Andrew Duncan PEACOCK, Edinburgh (GB); Edward Hugh OWENS, West Linton (GB); Manjula Saman Bandara DISSANAYAKE, Edinburgh (GB); David Wolfe CORNE, Edinburgh (GB)

(21) Appl. No.: 14/933,211

(22) Filed: Nov. 5, 2015

(51) Int. Cl. G01W 1/10; G06F 17/50

(52) U.S. Cl. CPC G01W 1/10; G06F 17/5009

(57) ABSTRACT

A computer implemented method for predicting localised weather for a location of interest using a plurality of different sources of weather variables associated with the location of interest, including multiple sources of weather observation variables and multiple sources of weather forecast variables, the method comprising: repeatedly retrieving using a computer processor weather observation variables and weather forecast variables from the identified plurality of different sources over time; storing the captured weather observation variables and weather forecast variables in a memory as a function of time; identifying using the computer processor specific observation variables and specific forecast variables from the stored variables for each specific weather variable that has to be predicted, wherein the weather variable to be predicted includes a specified time; and building using the computer processor and the identified specific observation variables and identified specific forecast variables a predictive model for each specific weather variable that has to be predicted.

### FIELD OF THE INVENTION

The present invention relates to a method and system for providing highly localised, short term weather predictions.

### BACKGROUND OF THE INVENTION

Localised short-term weather forecasting has many applications, for example in smart grid technology, which uses weather dependent renewable sources, such as wind turbines and solar panels. Current and future smart-grid technologies rely on accurate and up-to-date intelligence about the components of the power system, to enable optimized control decisions. Increasingly, such power systems are becoming integrated with renewable generation sources, which are well-known to be intermittent and challenging to predict. Progress in the smooth integration of renewables into smart grid control systems, particularly when it comes to hour-by-hour operation, therefore relies on progress in short term forecasting of renewables generation, which is in turn dependent critically on localised short-term weather forecasting.

Short term weather forecasting concerns predicting the values of meteorological variables typically between 1 and 48 hours in advance. This is important for a wide variety of applications that range through tourism, facility operation, agriculture, transport, and shipping (and consequently supply chain logistics in general), as well as energy management. As noted above, many smart grid planning and control scenarios rely on accurate short term predictions of renewable energy generation, requiring in turn accurate forecasting of wind speed, cloud cover, temperature and other such variables. Research into predicting future values of these variables at a specific location has been going on for decades, with resurgences of interest in recent years.

Current approaches for predicting short term weather forecast are (i) using sophisticated numerical weather prediction algorithms, which attempt to simulate physical and dynamical models of weather processes, (ii) statistical models built from local time series data, or (iii) hybrids and combinations of the latter two methods, particularly statistical downscaling, which builds statistical models using both numerical weather prediction forecasts and local data. Numerical weather prediction tends to be associated with large-scale models that provide forecasts for large regions (if not all) of the Earth's surface; such large-scale models are the basis, for example, of readily and regularly available forecasts issued by agencies such as the US National Ocean and Atmospheric Administration (NOAA) and the UK Meteorological Office (MetOffice).

Numerical weather prediction based weather forecasts alone, despite the benefit of a dynamical physics-based model, tend to be only sparsely informed by observation-based inputs at a local level. Pure statistical local models, though locally well-informed, suffer from their blindness to the wider meteorological context. These issues are well-known, and are addressed by statistical downscaling based approaches, which are increasingly used to provide better local forecasts that combine numerical weather prediction forecasts with local statistics. There remains, however, a need for simple, fast and accurate short term localised weather predictions.

### SUMMARY OF THE INVENTION

According to the present invention there is provided a method for predicting localised weather for a location of interest using a plurality of different sources of weather variables associated with the location of interest, including multiple sources of weather observation variables and multiple sources of weather forecast variables, the method involving repeatedly retrieving weather observation variables and weather forecast variables from the plurality of different sources over time; storing the captured weather observation variables and weather forecast variables as a function of time; identifying specific observation variables and specific forecast variables from the stored variables for each specific weather variable that has to be predicted, wherein the weather variable to be predicted includes a specified time ahead and the specific observation variables and specific forecast variables are a sub-set of the stored variables; and building a predictive model for each specific weather variable that has to be predicted. Identifying specific observation variables and specific forecast variables from the stored variables involves using at least one feature selection technique and applying the least one feature selection technique to all of the stored variables. As an example, forward selection may be used.

By harvesting a data stream of multiple forecasts and observations from a wide local region and building a predictive model for every weather variable to be predicted, short term localised weather predictions can be accurately made.

The method may involve storing captured weather observation variables and weather forecast variables for a period of time, not indefinitely. For example, for some variables, only the most recent two or three weeks of data may be stored. For other variables, only the most recent three or four days of data may be stored. The period of time may be determined in an initial analysis phase during which historic data is analysed. The period of time may be predetermined.

The method may involve repeating the steps of identifying specific observation variables and specific forecast variables and building the predictive model, so that each model is repeatedly rebuilt using the most up to date data that has been captured and stored. As an example, the predictive model may be rebuilt every three hours or every day or every three days.

Rebuilding the predictive model allows advantage to be gained from the constant updating of the weather observation variables and weather forecast variables data. Every time a model is rebuilt the entire stored data set is considered. No data is excluded. This is important because the stored data from the multiple observational and forecast sources changes dynamically with time as weather patterns change and/or shift.

The method may involve building a predictive model for a weather variable for each of multiple hours ahead, so that each hour ahead has its own model. For example, if the weather variable of interest is wind speed at 1 hour ahead and 2 hours ahead, then predictive models would be built for both. In practice, typically the weather variable of interest has to be predicted over a 24 hour period, in which case 24 predictive models are built. If both temperature and pressure are to be predicted from 1, 2, . . . up to 48 hours ahead, then 96 separate models are built.

According to another aspect of the invention, there is provided a computer implemented system for predicting localised weather for a location of interest using a plurality of different sources of weather variables associated with the location of interest, including multiple sources of weather observation variables and multiple sources of weather forecast variables, the system being adapted to repeatedly retrieve weather observation variables and weather forecast variables from the identified plurality of different sources over time; store the captured weather observation variables and weather forecast variables in a memory as a function of time; identify specific observation variables and specific forecast variables from the stored variables for each specific weather variable that has to be predicted, wherein the weather variable to be predicted includes a specified time; and build a predictive model for each specific weather variable that has to be predicted.

The system may be adapted to repeat identification of specific observation variables and specific forecast variables and building of the predictive model. The model may be rebuilt at regular intervals.

The system may be adapted to build a predictive model for each of multiple hours ahead, so that each hour ahead has its own model.

The system may be adapted to identify specific observation variables and specific forecast variables from the stored variables using at least one feature selection technique.

According to another aspect of the invention there is provided a computer program on a computer readable medium having code and/or instructions for predicting localised weather for a location of interest using multiple weather observation variables and multiple weather forecast variables, the code and/or instructions being adapted to: repeatedly retrieve weather observation variables and weather forecast variables from a plurality of different sources over time; store the captured weather observation variables and weather forecast variables in a memory as a function of time; identify specific observation variables and specific forecast variables from the stored variables for each specific weather variable that has to be predicted, wherein the weather variable to be predicted includes a specified time; and build using a predictive model for each specific weather variable that has to be predicted.

### BRIEF DESCRIPTION OF THE DRAWINGS

Various aspects of the invention will now be described by way of example only, and with reference to the following drawings, of which:

FIG. 1 is a schematic view of a weather prediction system polling weather observation sites and weather forecast sites for information;

FIG. 2 is a flow diagram of a process for short term, localised weather predictions;

FIG. 3 a map showing weather observation sites and weather forecast sites for a test site in Italy;

FIG. 4 shows wind-speed forecasts for Findhorn in Scotland from 1 hr ahead to 24 hrs ahead based on the invention (squares) and information derived directly from MetOffice forecasts (crosses);

FIG. 5 shows actual wind speed at Findhorn (solid line) together with the forecasts of the invention (circles) and the MetOffice forecasts (crosses);

FIG. 6 shows plots of cloud cover forecasts for Tamera in Portugal based on the invention (squares) and MetOffice-based forecasts (circles);

FIG. 7 shows plots of cloud cover forecasts for Tamera for an 18-hours ahead predictive model, showing the correlation between actual (vertical axis) and predicted values, for both the predictions of the invention (circles) and the MetOffice-based predictions (squares);

FIG. 8 shows cloud-cover forecasts at Damanhur in Italy from 1 hr ahead to 24 hrs ahead based on forecasts of the invention (crosses) and MetOffice based forecasts (circles);

FIG. 9 shows the correlation between actual cloud cover (vertical) and forecast cloud cover (horizontal), for 24 hrs-ahead at Damanhur, in this case Metoffice based forecasts are circles and the forecasts of the invention are crosses, and

FIG. 10 is a schematic diagram of a smart grid system that uses the weather prediction system of the invention to control or guide energy usage.

### DETAILED DESCRIPTION OF THE DRAWINGS

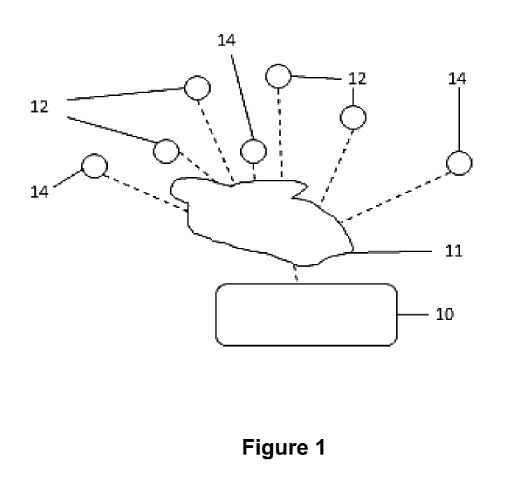

FIG. 1 shows a weather prediction system 10 in accordance with the invention that is connected to the internet 11. The system 10 uses a multiplicity of observational and forecast-based inputs from multiple observations sites 12 and multiple forecast sites 14 to determine highly localised, short term weather predictions. For predicting localised weather for a single location, typically over 50 different observations sites 12 and forecast sites 14 are used and more usually over 100 different sites.

Each observations site 12 provides weather variable observations including current values and historical values, typically for the previous 24 hours. Each forecast site 14 provides weather variable forecasts in the hours ahead typically over 24 or 48 hour periods. The weather prediction system 10 is a computer-based system that includes at least one computer processor and at least one memory. To make forecasts for a single location, for say five weather variables (such as temperature, cloud-cover, wind speed, rainfall and pressure) at each hour of the day would require typically 250 MB of hard disk memory, 500 MB of RAM and a processor, for example a 4-core workstation.

The weather prediction system 10 is operable to continuously poll the observations sites 12 and forecast sites 14 to capture weather related data. Captured data is stored in memory, typically in a database. By continuously capturing and storing forecast-based and observation based inputs and using these to continuously rebuild predictive models local predictions can be accurately adapted to current conditions. The captured weather observation variables and weather forecast variables are stored for a period of time. Some variables may be stored for two or three weeks, whereas others may be stored for three or four days. The period of time for which data is stored may be determined by analysing historic data.

The system 10 uses as much as possible the following freely data sources: (a) online sources: freely available weather observations and forecasts (typically numerical weather prediction based) for relevant sites around the location for which forecasts are needed; and (b) site data from a weather station installed on site (not always available).

The exploitation of online sources enables access to forecasts of weather variables that are often derived from large scale numerical weather prediction models. These are available from many sources, including the UK Meteorological Office (MetOffice), forecast.io (which provides forecasts that incorporate and interpolate from a variety of national services, including MetOffice, NOAA and so on), and Metar. From forecast.io, for example, hourly numerical weather prediction based forecasts can be obtained for up to and including 24 hours ahead, of several weather variables such as temperature, wind-speed, and cloud cover. Such forecasts are available for arbitrary locations. In addition to this, current and historical direct weather observations are available (for the same set of variables) for many thousands of locations, typically many within a 500 km radius of any specific site for which localized weather prediction may be required.

In accordance with the invention, site-specific forecasting models are built from this large pool of relevant available data for a location of interest. This will be referred to as the origin location. The origin location can be any location such as a village, campus, or individual building. To set up accurate localized short term weather forecasting at an origin location, there are three main stages: regional site selection, feature selection and machine learning.

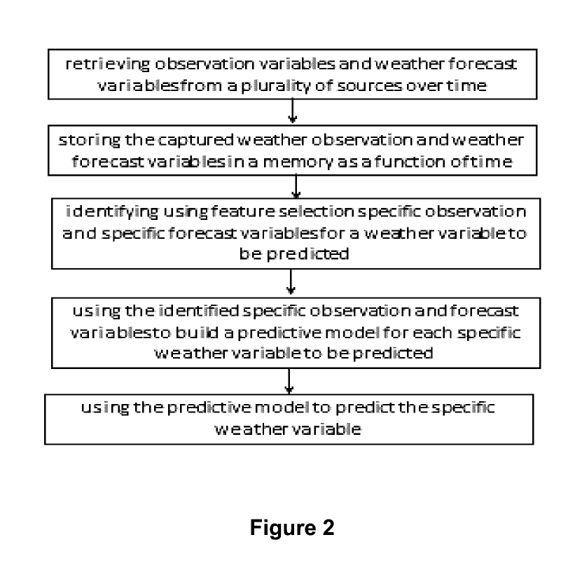

Regional site selection involves identifying for an origin location a collection of potentially relevant observation sites and forecast sites whose weather is likely to influence or be correlated with that of the origin location, at least at some times of year. These sites are able to provide data for use as inputs to allow modelling of localised observations and/or forecasts of meteorological variables. Where the origin location has a site weather station whose data stream is accessible online, the origin location is one of the forecast sites. Broadly speaking, site identification is done via access to lists of weather resources that can be accessed on-line from sources such as the MetOffice and forecast.io. Once the sites are selected, weather observation variables and weather forecast variables are repeatedly retrieved and stored over time from the plurality of different weather data sources, as shown in FIG. 2.

Feature selection involves identifying which specific forecast variables from the forecast sites and which specific observation variables from the observation sites to use for each specific weather variable that needs to be forecast at the origin location (see FIG. 2). This is vital for the following reasons. Around an origin location, the number of combined observation sites 12 and forecast sites 14 identified may typically be around 50. At each of these sites there are at least 10 potentially pertinent weather variables (for example, temperature, wind speed, cloud cover, pressure, humidity, dew-point, ozone, visibility, precipitation-intensity, precipitation-probability), and each of those has at least 24 time-based variants. For example, at a particular observation site 12, the observed wind-speed 1 hour ago, and observed wind speed 2 hours ago are separate weather variables which have different potential relevance to forecasts at the origin location. Consequently, on the order of 10,000 to 100,000 potential inputs are available for consideration, which is too many for a robust machine learning model. In general, feature selection is used in such scenarios, since there is a well-known trade-off between model accuracy and the number of features used in the model.

Machine learning involves building a model for each specific forecast variable from the selected features that will give predicted values for that variable. Note that ‘3-hours ahead wind-speed forecast’ and ‘4-hours ahead wind-speed forecast’ are two distinct forecast variables for which distinct predictive models are built based on distinct selected input features. The machine learning stage uses a specific statistical and/or machine learning algorithm to build a predictive model from the selected features. In general, there is a trade-off between generalization accuracy and robustness in this context. On the one hand, simple and robust machine learning algorithms could be used, such as multivariate regression or k-nearest-neighbour, at the expense of accuracy. On the other hand, more sophisticated approaches could be used, such as support vector regression, deep learning and so forth, but at the expense of complexity and sensitivity. Once the model for a specific weather variable is built, it can be used to predict short term, localised weather for the site of interest.

The weather prediction system of the invention typically uses ˜100-200 different observation sites and forecast sites, and collects 100-300 streams of information from each source (e.g. an observation of atmospheric pressure 6 hrs in the past is one stream of information, a forecast for humidity 5 hrs ahead is another, and so forth . . . ). This means that even if only one variable (e.g. wind-speed) is to be predicted, typically, around 50,000 data points have to be updated every hour. Hence, the system has to be capable of handling large volumes of data.

As well as having to be able large amounts of data, the weather prediction system 10 has to be able to build and re-build large numbers of predictive models. As an example, to predict the short term energy available from wind and solar installations, in a way that satisfies the fine-grained needs of supply/demand alignment, requires, minimally, the prediction of wind-speed, wind direction, temperature, and cloud-cover at points 1 hr, 2 hrs, 3 hrs, . . . up to 24 hrs ahead. This means that of the order of 100 models need to be learned, and regularly re-learned to track the regional weather dynamics.

Re-building the models is done by re-doing the feature selection process on a current version of all of the stored data and then rebuilding the models based on the results of that feature selection. Because the stored data is constantly being up-dated, and because weather patterns can be highly interlinked and interdependent, it is possible, indeed likely, the feature selection for a forecast variable of interest may vary over time. By redoing the feature selection and model building regularly, advantage can be taken of the dynamically changing stored observation and forecast data. This improves accuracy.

Once it has been decided that the system is to be set for an origin location, appropriate forecast sites and observation sites are identified. To do this, a partly automated ‘Data Source Choice’ procedure is used to identify appropriate forecast sites and observation sites for a given origin location. The broad procedure is as follows:

1. Identify a set of countries C that are swept within a 500 km radius of the original location;

2. For each country in C, obtain a list of observation sites and forecast sites from globally-serving resources (such as MetOffice and forecast.io—which invariably categorize their site resources by country);

3. For each country in C, obtain a list of observation sites and forecast sites from regional resources that are freely available from the original location. (these are additional services that are only freely available in the country of the origin location—e.g. the MetOffice provides observations for some UK sites that are not available outside the UK);

4. From the lists of resources identified in steps 3 and 4, activate web-scraping and similar code, for example to harvest data from relevant application programming interfaces, to extract precise locations of the available forecast sites and observation sites;

5. Construct a map showing the observation sites and forecast sites identified so far, and also showing the origin location;

6. Use the map to select a network of weather forecasts and observations surrounding the origin location so that a weather front approaching the pilot site from any direction is covered by at least one or more of this network of weather observations/forecasts.

It may suffice to select sites in step 6 based on a common sense view of covering the geographical area, without undue redundancy. Step 6 may benefit from the help of meteorological expertise. In fact, with recourse to a suitable meteorological knowledge-base, step 5 may be omitted.

Whilst the regional site selection described above can be done manually, it could equally be automated.

For each of the observation sites and forecast sites, the main list of weather variables available is typically as follows: temperature, pressure, visibility, cloud cover, humidity, dew point, wind speed, wind bearing, apparent temperature, precipitation intensity, nearest storm.

This core subset is often embellished by additional variables, especially when an online-accessible weather station is available at the origin location, in which for example solar irradiance observations may also be available. Since the observation sites provide a stream of observations (and can also typically provide historical observations on request), historical observations tend to be available for every hour of every day, and certainly for as far back would be expected to be relevant. In contrast, forecasts are forward looking and so tend to be available from the specific time-points, such as 00:00, 03:00, . . . , etc, . . . 21:00, 24:00. That is, at 15:30 pm, for example, forecasts can be obtained (e.g. from the MetOffice) of each variable for 18:00, 21:00 and so forth, up to 18:00 the next day.

Some forecast resources provide finer grained time points, which may or may not be interpolations from yet other forecast resources. In line with observations from review and preliminary research, historical observations of up to 24 hours back can be considered more than sufficient for short term forecasting. For each individual observation site, and for each type of observation, there are 25 features—these are the current observation (e.g. at 14:00), and the 24 recent historical observations (ranging from 13:00 on the same day back to 14:00 the previous day). For each forecast site, similarly there are 24 features: these are the individual forecasts for each of the next 24 hours.

Some forecasts can be expected to be at hourly time points and others interpolated. For example, the MetOffice provides a forecast of temperature 3 hrs ahead and another forecast for 6 hrs ahead. Simple interpolation between these is used to obtain MetOffice forecasts for 4 hrs ahead and 5 hrs ahead. The 3 hr ahead and 6 hr ahead MetOffice forecasts are actual forecasts, which will be referred to as ‘first class’ features. The 4 hr ahead and 5 hr ahead forecasts are only interpolations. For the sake of simplicity interpolations are treated in the same was as actual forecasts, i.e. interpolated features are treated as first-class features. Also, it is noted that building predictive models for and using forecasts of up to 24 hours ahead is a simplification in the current exposition, representing minimal requirements for applications.

Once the sites are selected, the feature selection process begins. This uses a process known as forward selection, which is particularly applicable for large feature sets. The technique is characterized by the following algorithm, where a specific weather variable V is to be forecast (e.g. “temperature 4 hours ahead”):

1. Repeat the following steps for 100 iterations, and return the feature set with the highest quality

2. For each feature f that is marked available, construct the set of features and estimate the quality of this set at predicting V.

3. Let b be the feature that provided the best quality in step 2.

4. Mark b as unavailable and set S ←S U {b}

5. Perform tests on each variable other than b in S to determine if it can be removed without reducing quality.

Whilst forward selection is described here, it will be appreciated that any suitable form of feature selection could be used. Feature selection techniques are well known in the art and so will not be described in detail.

The choice of 100 iterations arises from preliminary findings that this is sufficient to capture the best feature sets for the variables of interest. Quality is estimated using multivariate linear regression. For appropriate variables, the multivariate egression prediction is wrapped by a simple routine that keeps it in range (for example, cloud-cover proportion is strictly between 0 and 1 inclusive). Otherwise standard multivariate linear regression is used, using the Singular Value Decomposition via the well-known Golub-Reinsch algorithm (implemented via the gnu scientific library). The standard RMSE metric is used to estimate the quality of a model. It will be appreciated that other techniques could be used in this context, for example regression trees.

As previously indicated, typically 24 specific values are forecast for each variable, covering from 1 to 24 hours ahead inclusive. To meet overall requirements, this means, altogether, 168 feature selection runs leading to 168 specific predictive models. Note, for example, that the model which predicts wind-speed 2 hours ahead may use observation sites further away from the origin location than the model which predicts wind-speed 1 hour ahead. The demands of frequently building multiple predictive models require the implementation of fast and robust systems with few hyper-parameters. Such promises reasonable accuracy all or most of the time, while more complex approaches tend to run the risk of occasional poor predictions. Currently, multivariate regression is used, i.e. the model returned by the feature selection stage.

In addition to the above functionality, the system includes a suite of ‘failsafe forecasting’ routines, which provide failsafe versions of the predictive models that are to be used when insufficient up-to-date data is available, for example due to transient issues with the connectivity or the data source. These failsafe models range from alternative predictive models using different feature sets, through to (for use in the worst case) tables of mean values from historical data. Also, an overarching control structure is provided that repeats the feature selection stage regularly for each model (subsequently updating it if necessary), and also updates the failsafe models and tables. This component ensures that the predictive models appropriately keep track of the regional weather dynamics. As the year progresses, the appropriate features for predicting weather variables at the origin location will change according to meso-scale weather patterns, and this is echoed by changes in the outcomes of the successive feature selection stages (for example, once per week).

The invention has been used to forecast the primary meteorological variables of importance to renewables generation at three different origin locations: Findhorn in Scotland, Damanhur in Italy and Tamera in Portugal. The primary meteorological variables are wind-speed at Findhorn, and cloud-cover at both Damanhur and Tamera. In each case, the data source choice procedure was executed to identify observations sites 12 and forecast sites 14 of interest, resulting in 19,232 features for Findhorn, 27,288 features for Tamera, and 26,198 features for Damanhur. Note that in these examples site weather station data was not included.

In the case of Findhorn, 24 predictive models were built, respectively for wind-speed 1 hr, 2 hrs, and so on, up to 24 hours ahead. Each was produced by performing feature selection, and returning the model that performed best during the forward selection process. In the cases of both Tamera and Damanhur, the same process was followed, but for predicting cloud-cover rather than wind-speed. Each of the 72 predictive models was trained on two weeks of hourly data (14th to 28th March 2014), where the quality of a model was estimated by the mean value of its RMSE over five randomized selections of 30% of the training set.

All results presented below arise from testing the models on the subsequent two weeks of data (29th March to 11th April 2014). The results are evaluated by contrasting them with the performance of the analogous UK MetOffice forecasts, where the target value is always the subsequent MetOffice observation at the applicable number of hours ahead. In fact, the latter are improved Met-Office based forecasts, also built from a small regression model (one coefficient and one constant) on the training datasets, that used the MetOffice forecast as its input, hence applying a light form of statistical downscaling. This was always slightly more accurate than the MetOffice forecast alone. Persistence based forecasts were omitted, as these were always significantly poorer than the results presented at all timescales.

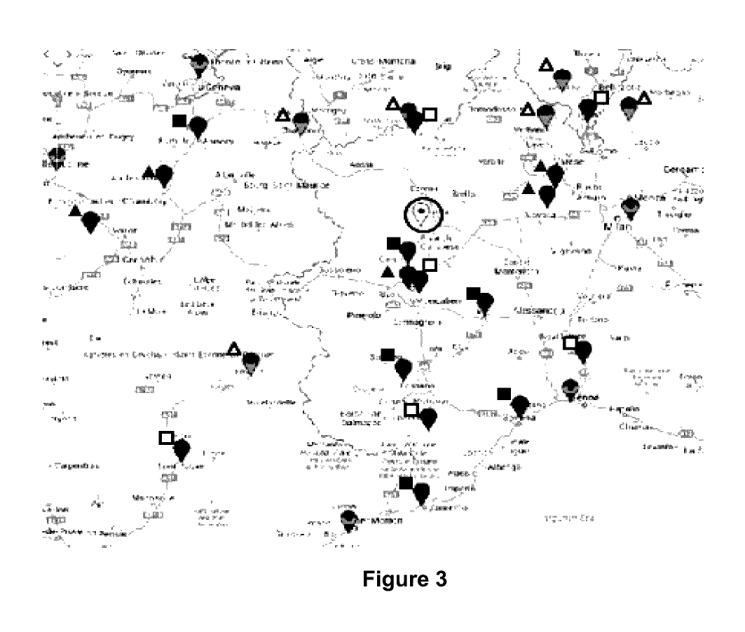

FIG. 3 shows selected observation sites and forecast sites for Damanhur (shown inside a black ring). Each data source is shown as a balloon-shaped ‘pin’. Adjacent markers indicate the data available at each source as follows: white square—Metar observations; black square—MetOffice forecasts; white triangle—MetOffice observations and MetOffice forecasts; black triangle—Metar observations and MetOffice forecasts; no adjacent marker—Metar observations, MetOffice observations, and MetOffice forecasts.

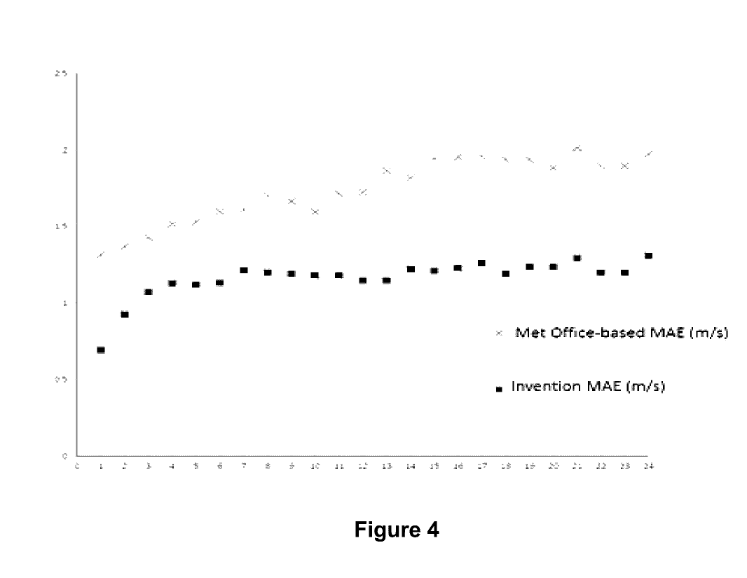

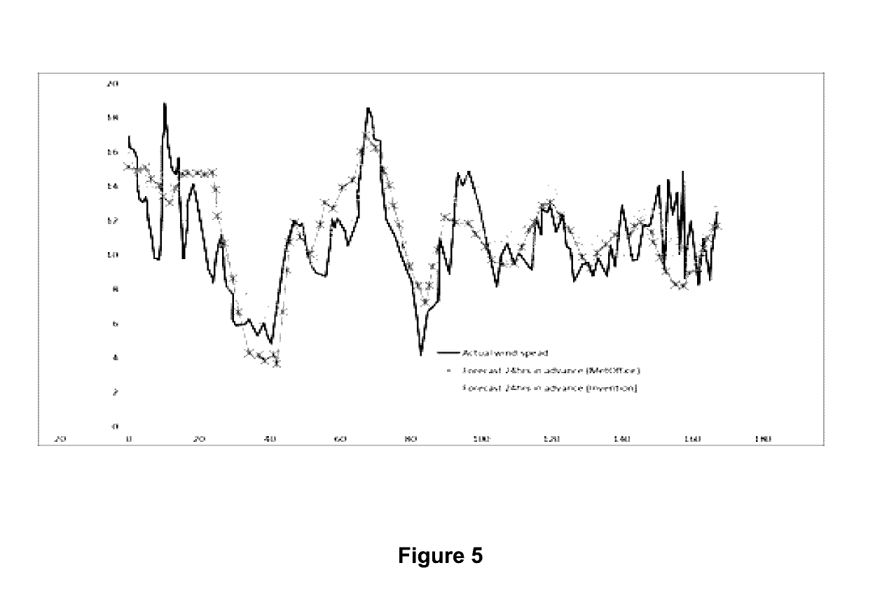

FIG. 4 shows wind-speed forecasts at Findhorn from 1 hr ahead to 24 hrs ahead, measured on unseen data, comparing the forecasts based on the invention (squares) with forecasts for the same location derived directly from MetOffice forecasts (crosses). From left to right are plotted the 1 hr, 2 hrs . . . up to 24 hrs ahead models, where the vertical axis shows mean absolute error in metres per second. FIG. 5 provides a closer look at how both the forecasts of the invention and the MetOffice forecasts track actual wind-speed, in both the 1 hr ahead and 24 hrs ahead cases. In this case, actual the wind-speed at Findhorn is show as a solid line, compared with the invention forecasts marked by circles and Met-office based forecasts marked by crosses. The plot shows 24 hr ahead forecasts.

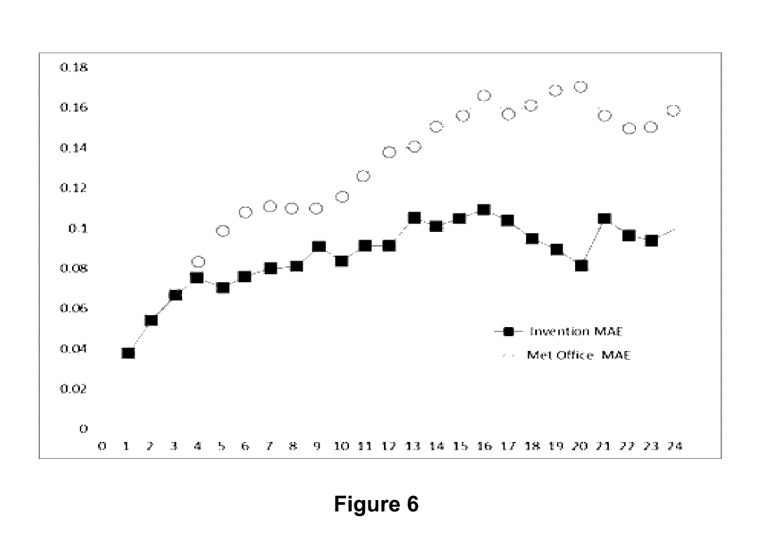

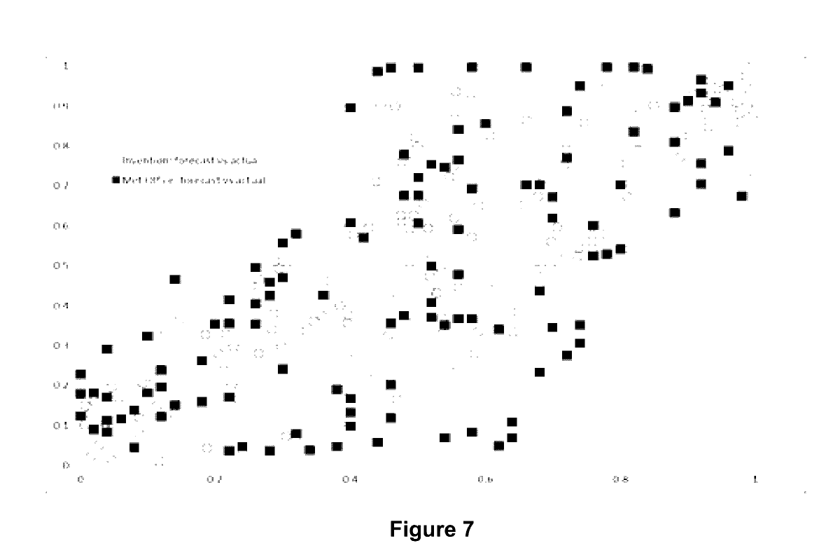

FIG. 6 summarizes the performance of the cloud-cover forecasting models of the invention for Tamera (squares), contrasted with MetOffice-based forecasts (circles). Cloud-cover is measured as a proportion that ranges from 0 (clear sky) to 1 (100% cloud cover). Again, from left to right are plotted the 1 hr, 2 hrs . . . up to 24 hr ahead models, where the vertical axis shows the mean absolute error. FIG. 7 provides a closer look at the 18-hours ahead predictive model, showing the correlation between actual (vertical axis) and predicted values, for both the predictions of the invention (circles) and the MetOffice-based predictions (squares).

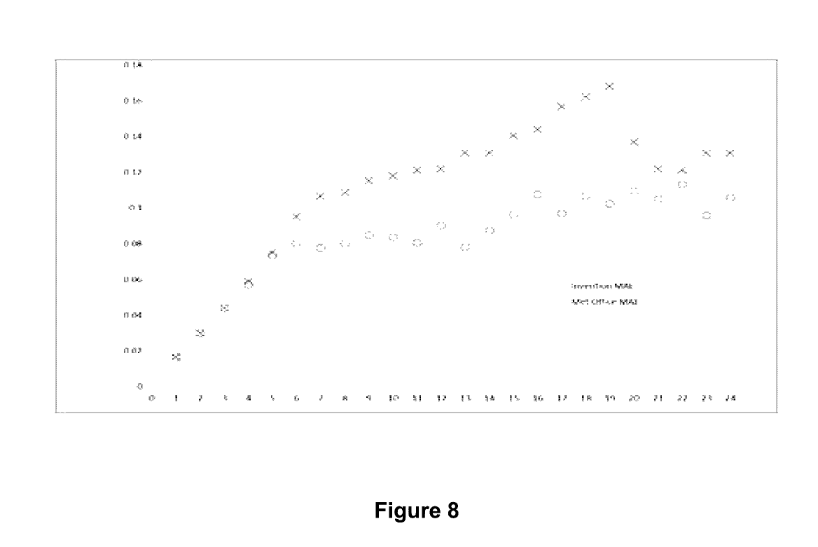

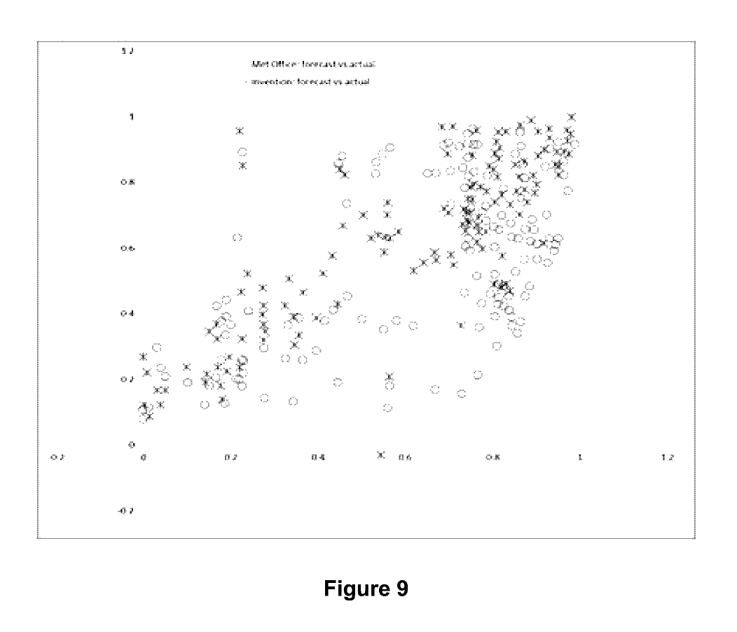

FIG. 8 shows cloud-cover forecasts at Damanhur, Italy, from 1 hr ahead to 24 hrs ahead, measured on unseen data, comparing the forecasts of the invention (circles) with MetOffice based forecasts (crosses). From left to right are plotted the 1 hr up to 24 hr ahead models, and the vertical axis shows the mean absolute error. FIG. 9 shows the correlation between actual cloud cover (vertical) and forecast cloud cover (horizontal), for 24 hrs-ahead at Damanhur. Metoffice based forecasts are marked by circles and the forecasts of the invention are marked by crosses.

The present invention provides a new approach to localized weather prediction, which involves harvesting freely available weather data resources that refer to the wide geographical region around a forecast site. The approach is responsive to changes in the regional weather dynamics, and yields accurate predictive models via judicious exploitation of multiple data sources. The approach is capable of providing forecasts of many meteorological variables at arbitrary locations around the globe. The richness and quantity of the harvested data sources enables accurate forecasting despite a simple core predictive model (multivariate regression). Better localized forecasts may be achievable by using more sophisticated machine learning techniques.

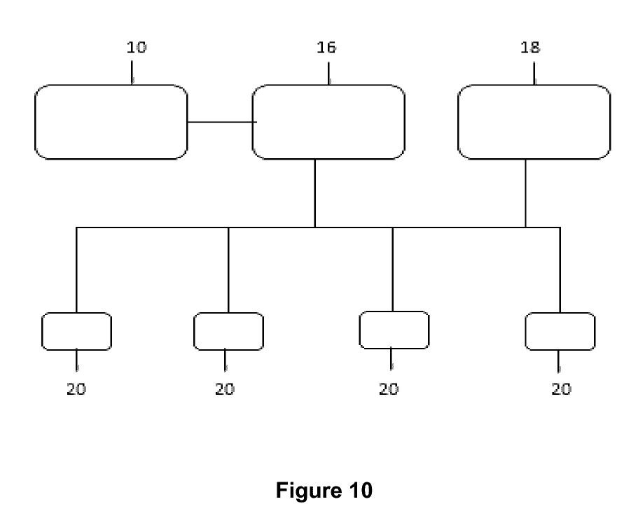

FIG. 10 shows a smart grid control architecture that is adapted to use the weather forecasting system 10 described above to actuate opportunities optimizing the alignment of household and office energy demand with renewables supply. This has a central controller 16 that is operable to control appliances in households and office buildings in an origin location where a weather dependent energy supply 18 is being used. The controller is adapted to act in response to weather predictions from the weather prediction system 10.

Any electrical appliances 20 that are on-line or can be connected to the controller 16 can be controlled such as freezers, water heaters and electric vehicle chargers. Alternatively or additionally the controller 16 can provide targeted information to households and office buildings, in order to optimize the alignment of predicted demand with predicted supply of renewables in the short term. For example, the controller 16 may send a message to households and office buildings to let them know that high levels of energy will be available (for example from a local wind turbine) between 4 and 6 pm in the evening. This gives those households the opportunity to made good use of the available power.

Included in the controller 16 is a suite of models of thermal and electrical controllable loads (such as water heaters and battery chargers), which is used to identify a collection of daily shiftable opportunities. Each represents a portion of predicted energy demand that could be shifted forward or backward in time with little or no cost to the end user. Coupled with continually forecasting both renewable supply and energy demand for households and individual buildings, the smart grid control strategy continually identifies subsets of these shiftable opportunities that will collectively optimize the community's goals. Typically the community goals centre on alignment of demand with renewables supply, so that the community maximizes its use of generated renewable energy (which can, in some cases, be exported) and reduces its reliance on imported fossil fuel based energy. In some cases, community goals may also include elements relating to economic cost, such as preferring the use of energy when tariffs for imported electricity are most favourable.

By considering demand/supply alignment at both community level and individual building level, the potential for improved utilization of renewables goes beyond what is achievable by considering individual buildings alone. This can help unlock the potential of a community's installed renewable generation resources to achieve carbon emission savings that are usually severely curtailed by the well-known intermittency of renewable energy supply and its typically poor alignment with demand. By providing accurate local short term forecasting this balance between supply and demand can be optimised.

A skilled person will appreciate that variations of the disclosed arrangements are possible without departing from the invention. For example, the invention could be used to predict variables that are dependent on the weather, but not usually considered a weather variable. For example, the invention could be applied to pollution and/or pollen count. In this case, at least one observational site for pollution and/or pollen count would have to be included in the plurality of different sources. Accordingly, the above description of the specific embodiment is made by way of example only and not for the purposes of limitation. It will be clear to the skilled person that minor modifications may be made without significant changes to the operation described.

1. A computer implemented method for predicting localised weather for a location of interest using a plurality of different sources of weather variables associated with the location of interest, including multiple sources of weather observation variables and multiple sources of weather forecast variables, the method comprising:
repeatedly retrieving using a computer processor weather observation variables and weather forecast variables from the identified plurality of different sources over time;
storing the captured weather observation variables and weather forecast variables in a memory as a function of time;
identifying using the computer processor specific observation variables and specific forecast variables from the stored variables for each specific weather variable that has to be predicted, wherein the weather variable to be predicted includes a specified time; and
building using the computer processor and the identified specific observation variables and identified specific forecast variables a predictive model for each specific weather variable that has to be predicted.

2. A method as claimed in claim 1 comprising repeating the steps of identifying specific observation variables and specific forecast variables and building the predictive model.

3. A method as claimed in claim 1 comprising rebuilding the predictive model at regular intervals.

4. A method as claimed in claim 1 comprising building a predictive model for each of multiple hours ahead, so that each hour ahead has its own model.

5. A method as claimed in claim 1 wherein identifying specific observation variables and specific forecast variables from the stored variables involves using at least one feature selection technique.

6. A method as claimed in claim 1 comprising identifying the plurality of different sources of weather variables associated with the location of interest.

7. A computer implemented system for predicting localised weather for a location of interest using a plurality of different sources of weather variables associated with the location of interest, including multiple sources of weather observation variables and multiple sources of weather forecast variables, the system being adapted to:
repeatedly retrieve weather observation variables and weather forecast variables from the plurality of different sources over time;
store the captured weather observation variables and weather forecast variables in a memory as a function of time;
identify specific observation variables and specific forecast variables from the stored variables for each specific weather variable that has to be predicted, wherein the weather variable to be predicted includes a specified time; and
build using a predictive model for each specific weather variable that has to be predicted.

8. A system as claimed in claim 7 adapted to repeat identification of specific observation variables and specific forecast variables and building of the predictive model.

9. A system as claimed in claim 7 adapted to build the predictive model at regular intervals.

10. A system as claimed in claim 7 adapted to build a predictive model for each of multiple hours ahead, so that each hour ahead has its own model.

11. A system as claimed in claim 7 adapted to identify specific observation variables and specific forecast variables from the stored variables using at least one feature selection technique.

12. A computer program product having code and/or instructions for predicting localised weather for a location of interest using multiple weather observation variables and multiple weather forecast variables, the code and/or instructions being adapted to:
repeatedly retrieve weather observation variables and weather forecast variables from a plurality of different sources over time;
store the captured weather observation variables and weather forecast variables in a memory as a function of time;
identify specific observation variables and specific forecast variables from the stored variables for each specific weather variable that has to be predicted, wherein the weather variable to be predicted includes a specified time; and
build using a predictive model for each specific weather variable that has to be predicted.
